(19) United States
(12) Patent Application Publication
(10) Pub. No.: US 2013/0263033 A1
(43) Pub. Date: Oct. 3, 2013

(54) OBJECT TAGGING

(71) Applicants: Nir Yom Tov, Rehovot (IL); Noy Bar, Meitar (IL); Ronen Shmiel, Ramat-Gan (IL)

(72) Inventors: Nir Yom Tov, Rehovot (IL); Noy Bar, Meitar (IL); Ronen Shmiel, Ramat-Gan (IL)

(21) Appl. No.: 13/436,428

(22) Filed: Mar. 30, 2012

(51) Int. Cl. G06F 3/048

(52) U.S. Cl. 715/769; 715/810; 715/825

(57) ABSTRACT

An object tagging method includes causing, in a user interface displaying managed objects, a display of a plurality of user defined classification controls proximal to the objects. The classification controls are caused to be displayed such that user interface actions can visually link any plurality of the managed objects to any given one of the classification controls. A user interface action visually linking a selected one of the objects to a selected one of the classification controls is, and the selected one of the objects is tagged with data corresponding to the selected one of the classification controls.

### BACKGROUND

Software applications manage or otherwise utilize varying data object types. As examples, personal information managers work with objects such as electronic messages, tasks, and events, and IT management tools coordinate objects such as incidents and application defects. As a list of objects grows, it can become difficult for the user of the application prioritize or otherwise ensure appropriate action is taken with respect to a given object. An IT management tool may handle application defects of varying sorts ranging from user interface defects to performance defects to documentation defects. Each defect is represented by a corresponding object. Each object can identify a status of the defect, an individual assigned to address the defect, plus any other relevant information. As the object increase in number, it becomes more and more difficult for a project manager to ensure that the corresponding defects are being assigned to the correct personnel and addressed in a in a timely, prioritized fashion.

### DRAWINGS

FIG. 1 depicts an environment in which various embodiments may be implemented.

FIG. 2 depicts a system according to an example.

FIG. 3 is a block diagram depicting a memory and a processor according to an example.

FIG. 4 is a flow diagram depicting steps taken to implement examples.

FIGS. 5-9 depict screen views of a user interface including classification controls displayed proximal according to examples.

### DETAILED DESCRIPTION

Introduction:

Software applications manage or otherwise utilize varying data object types. Embodiments, described in detail below, aid in efficiently organizing such managed objects in an efficient manner while also being personal to the user of the application. In other words, various embodiments allow the user to define a number of categories and easily assign a given category to a given managed object. Such assignment can be referred to as tagging. “Managed object” is used herein to refer to an entity being managed by an application. The specific nature of the entity depends on the type of application. For example, where the application is an e-mail program, the objects being managed may be e-mail messages. Where the application is an IT management tool, the objects may correspond to defects or incidents. Typically, an application causes representations the objects being managed to be displayed in a user interface. Thus, “managed object” can refer both to the actual object data as well as the user interface representation of the managed object.

In an example implementation, managed object tagging is accomplished by displaying a group of user defined classification controls proximal to the objects being managed by an application. The classification controls are caused to be displayed such that user interface actions can visually link any plurality of the managed objects to a given one of the classification controls. With the classification controls displayed, a user interaction visually liking a selected one of the managed objects to a selected one of the classification controls is detected. The selected managed object is then tagged with data corresponding to the selected classification control. This data or “tag” is user defined information associated with the selected classification control.

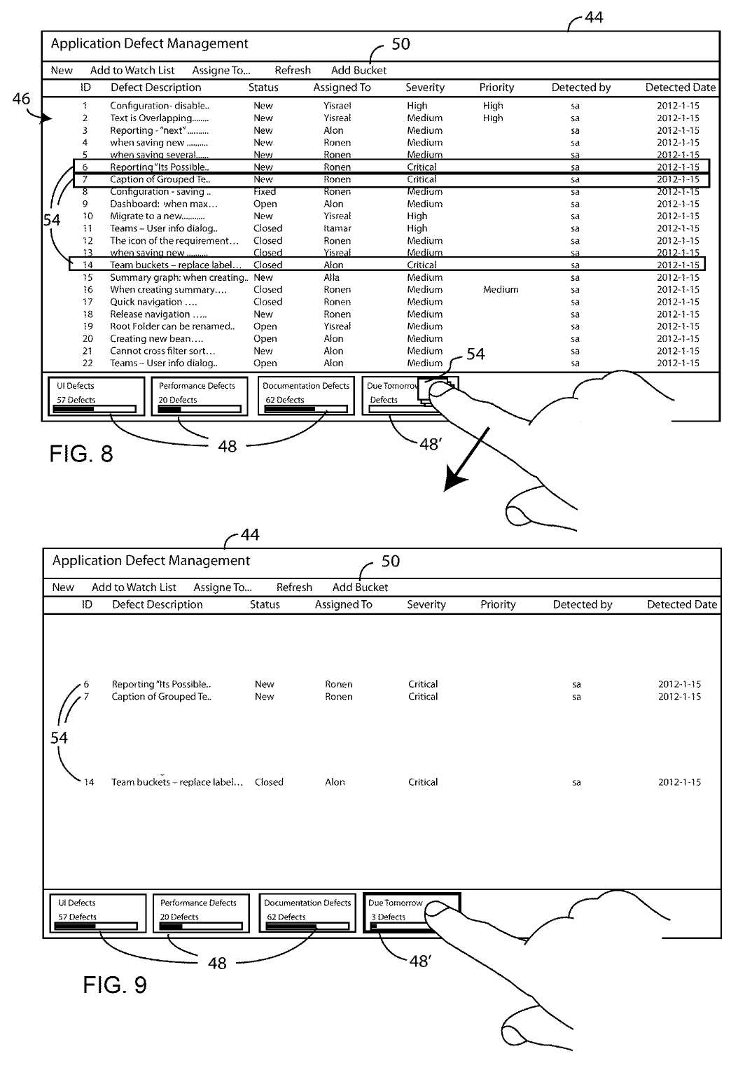

An example display of classification controls is depicted in FIGS. 5-9 and discussed below. In general, a classification control is a user interface object with which a user interacts to tag a selected managed object. Here that interaction is a user interface action in which the selected managed object is visually linked to a selected classification control. Visual linking is defined as a user directed action in which a user interface visually associates a selected managed object with a selected classification control. An example includes a drag and drop visual interaction in which the managed object is dragged on top of the classification control. Another example might include a selection of the managed object's screen representation with a mouse or other human input device followed by a selection of the classification control. The classification controls are user defined in that the user is able to associate each classification control with desired data.

The following description is broken into sections. The first, labeled “Environment,” describes and example of a network environment in which various embodiments may be implemented. The second, labeled “Components,” describes examples of physical and logical components for implementing various embodiments. The third section, labeled “Operation,” describes steps taken to implement various embodiments.

Environment:

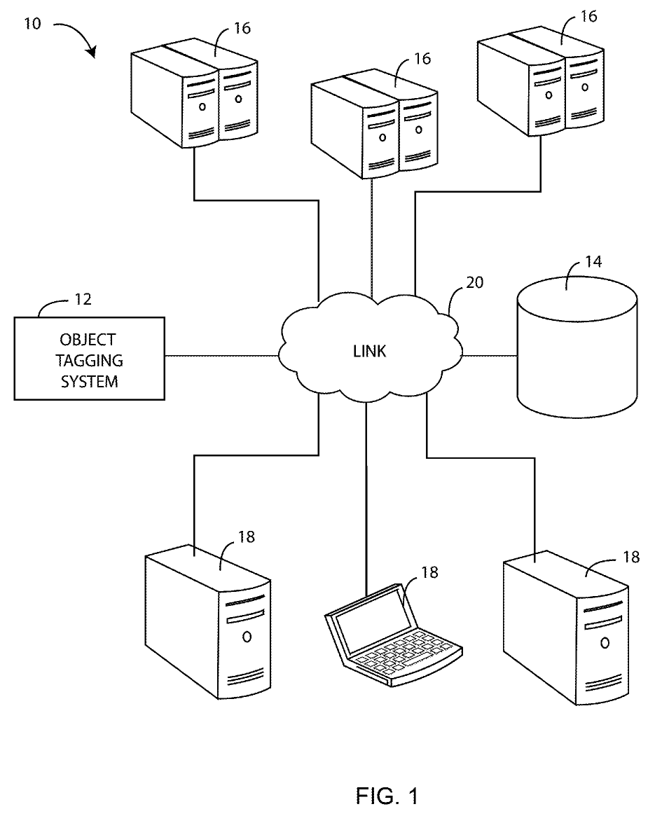

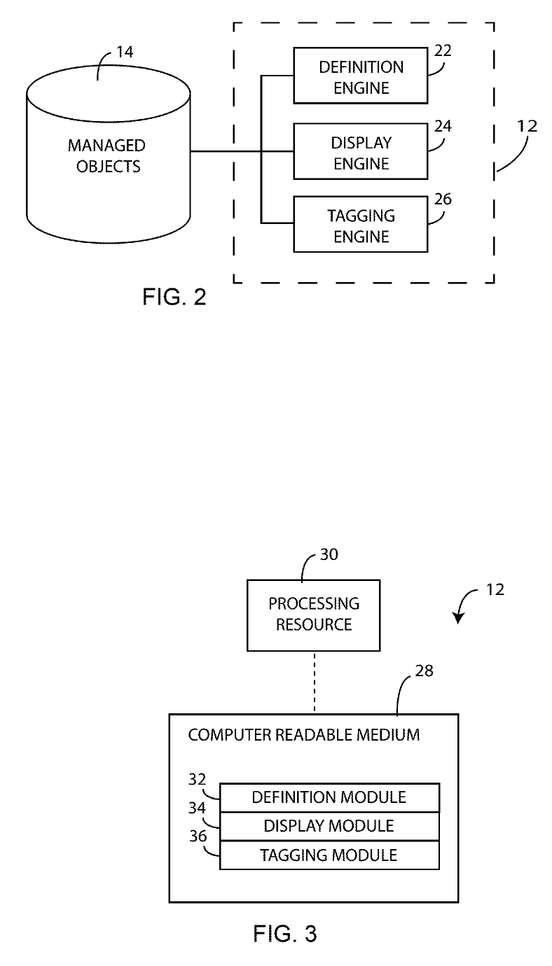

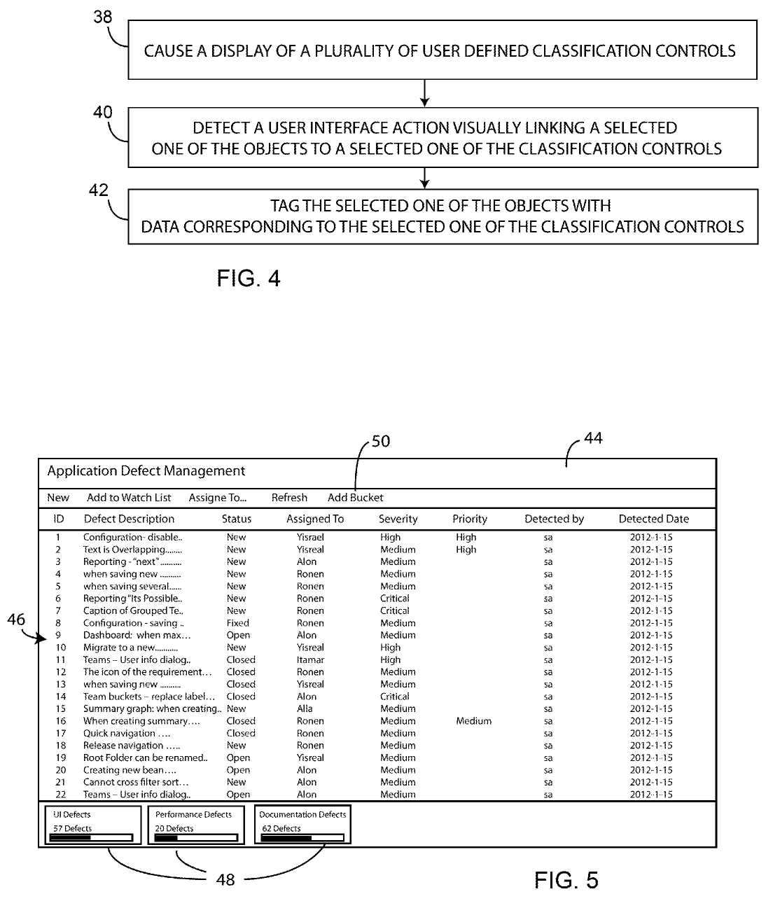

FIG. 1 depicts an environment 10 in which various embodiments may be implemented. Environment 10 is shown to include object tagging system 12, data store 14, server devices 16, and client devices 18. Object tagging system 12, described below with respect to FIGS. 2 and 3, represents generally a combination of hardware and programming configured to assign tags to objects managed by an application. The application Data store 14 represents generally any device or combination of devices configured to store data for use by object tagging system 12. Such data may include the managed objects. Data store 14 may be autonomous from server devices 16 and client devices 18, it may be integrated into a given device 16 or 18, or it may be distributed across multiple devices 16 and 18.

In the example of FIG. 1, the managed objects represent the entities being managed by an application executing or otherwise installed on a server device 16, a client device 18, or a combination thereof. Server devices 16 represent generally any computing devices configured to serve applications and data for consumption by client devices 18. A given server device 16 may include a web server, an application server, or a data server. Client devices 18 represent generally any computing devices configured with browsers or other applications to communicate requests to and receive corresponding responses from server devices 16. Link 20 represents generally one or more of a cable, wireless, fiber optic, or remote connections via a telecommunication link, an infrared link, a radio frequency link, or any other connectors or systems that provide electronic communication between components 12-18. Link 20 may include, at least in part, an intranet, the Internet, or a combination of both. Link 20 may also include intermediate proxies, routers, switches, load balancers, and the like.

In the example of FIG. 1, object tagging system 12 enables a user of an application whose user interface is being displayed by a client device 18 to assign tags defined by the user to objects managed by the application. Object tagging system 12 may be autonomous or it may be provided by one or more of devices 16 and 18. In one example, the programming of system 12 may be integrated with the application managing the objects. In another example, the programming may be independent of or an add-on to the application.

Components:

FIGS. 2-3 depict examples of physical and logical components for implementing various embodiments. FIG. 2 depicts object tagging system 12 in communication with data store 14. Data store 14 is shown as containing the managed objects of an application. In the example of FIG. 2, system 12 includes definition engine 22, display engine 24, and tagging engine 26. Definition engine 22 is responsible for allowing a user to define object classification controls. Display engine 24 is responsible for causing a display of the user defined object classification controls. Upon detecting a user interface action visually linking the selected object to the selected classification control, tagging engine 26 is responsible for associating that managed object with data corresponding to the selected object control. In other words, tagging engine 26 tags the managed object.

More specifically, definition engine 22 represents generally a combination of hardware and programming configured to define a plurality of classification controls according to user input. In performing this task, definition engine may receive user input specifying a tag that can be associated with a managed object. Where, for example, the managed object is a task, the user input may specify a tag specifying a due date or a tag defining a task type. In other words, definition engine 22 performs its function by collecting user input specifying various tags and then defines the classification controls such that each control corresponds to a different one of the user specified tags.

Display engine 24 represents generally a combination of hardware and programming configured to cause, in a user interface displaying managed objects, a display of the plurality of user defined classification controls proximal to the objects. Display engine 24 performs this function in a manner that allows user interface actions to visually link any plurality of the managed objects to any given one of the classification controls. In other words, the display of the classification controls allows for a single managed object to be visually linked to a one or more of the classification controls. Also, multiple managed objects can be selected and then visually linked simultaneously to a common classification object. Examples are described below with reference to FIGS. 5-9.

Causing a display can be achieved by directly interacting with the graphics hardware responsible for displaying the user interface. Causing a display can also be achieved indirectly by generating and communicating electronic data that can be processed and displayed. With the direct approach, display engine 26 may operate on a client device 18 where it can directly control the display. With the indirect approach, display engine 24 may be operate on a server device 16 where it communicates the information to be processed by a client device 18 to be displayed.

Tagging engine 26 represents generally a combination of hardware and programming configured to tag a selected one of the managed objects with data corresponding to a selected one of the classification controls. Tagging engine 26 does so upon detecting a user interface action that visually links the selected object to the selected classification control. Tagging engine 26 may be responsible for detecting as such a user interface action in which the selected managed object is dragged and dropped on the selected classification control. In tagging the managed object, tagging engine 26 may alter the managed object so that it includes the user defined information corresponding to the classification control in question. Instead, tagging engine 26 may maintain a table or other data structure linking identifiers for the managed objects to the corresponding user defined information.

In a particular example, display engine 24 causes, in the user interface, a display of a tag control. A tag control is a user interface control with which a user can interact to alter the plurality of classification controls. Such alterations can include adding a classification control, deleting a classification control, specifying a tag for an added classification control or updating a tag for an existing classification control or modifying tag corresponding to an existing classification control. Definition engine 22 can then alter the plurality of classification controls according to a user's interaction with the tag control.

In another example, display engine 24 is responsible for filtering the display of the managed objects according to the data tagged to those objects. In other words, tagging engine 26 may tag different managed objects with different tags based on which classification control each managed object is visually linked to. Thus, upon a user's selection of a given classification control, display engine 24 can filter the display of the managed objects such that only the managed object being tagged using that classification control are visible. Alternatively, display engine 24 may highlight those managed objects such that they are visually distinguished from the others. Thus, tagging engine 26 may detect a first user interface action or series thereof visually linking a first plurality of the managed objects with a first one of the classification controls. Tagging engine 26 may then detect a second user interface action or series thereof visually linking a second plurality of the managed objects with a second one of the classification controls. In doing so, tagging engine 26 tags the first and second pluralities of managed objects with data corresponding to the first and second classification controls respectively. Once the first and second pluralities of managed objects are tagged, display engine 24 can then filter the display of the managed objects such that the first plurality of manage objects are visually distinguishable as a set different from the second plurality of managed objects.

In foregoing discussion, engines 22-26 were described as combinations of hardware and programming. Such components may be implemented in a number of fashions. Looking at FIG. 3, the programming may be processor executable instructions stored on tangible, non-transitory computer readable medium 28 and the hardware may include processing resource 30 for executing those instructions. Processing resource 30, for example, can include one or multiple processors. Such multiple processors may be integrated in a single device or distributed across devices. Medium 28 can be said to store program instructions that when executed by processing resource 30 implements system 12 of FIG. 2. Medium 30 may be integrated in the same device as processor resource 32 or it may be separate but accessible to that device and processor resource 32. Medium 30 may represent an individual volatile or nonvolatile memory device. It may also represent multiple disparate memory types centrally located or distributed across devices.

In one example, the program instructions can be part of an installation package that when installed can be executed by processing resource 30 to implement system 12. In this case, medium 28 may be a portable medium such as a CD, DVD, or flash drive or a memory maintained by a server from which the installation package can be downloaded and installed. In another example, the program instructions may be part of an application or applications already installed. Here, medium 28 can include integrated memory such as a hard drive, solid state drive, or the like.

In FIG. 3, the executable program instructions stored in medium 28 are represented as definition module 32, display module 34, and tagging module 36 that when executed by processing resource 30 implement system 12 (FIG. 2). Definition module 32 represents program instructions that when executed function as definition engine 22. Display module 34 represents program instructions that when executed function as display engine 24. Likewise, tagging module 36 represents program instructions that when executed implement tagging engine 26.

Operation:

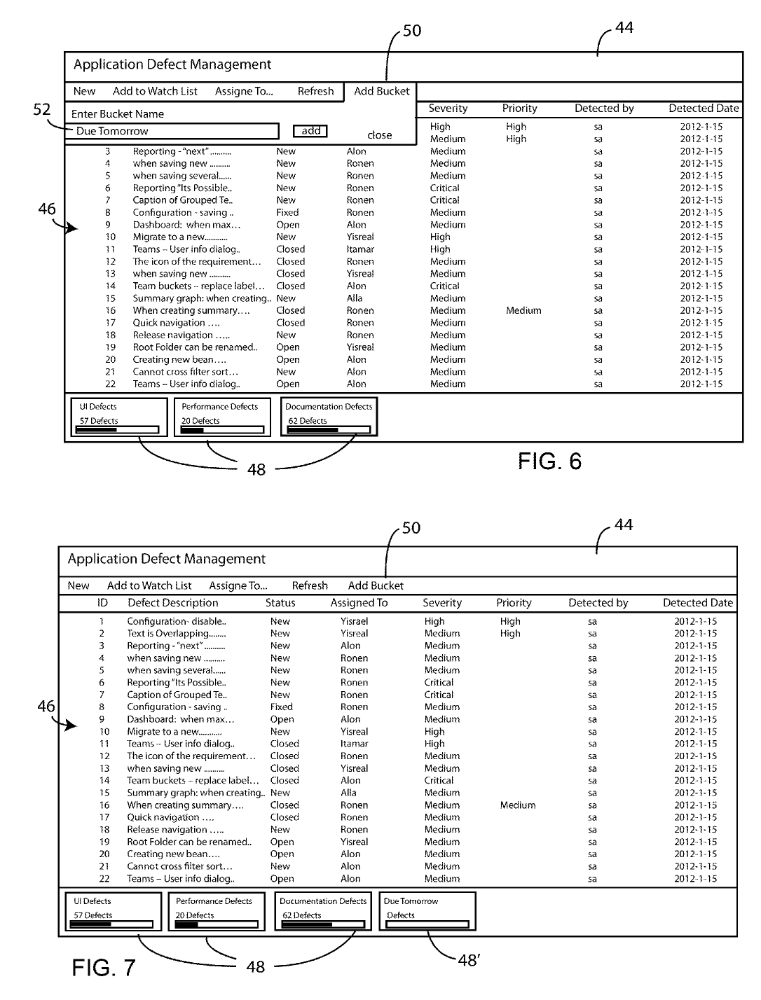

FIG. 4 is a flow diagram depicting steps taken to implement various examples. FIGS. 5-9 depict screen views of a user interface displaying user defined classification controls proximal to a plurality of managed objects. In discussing FIGS. 4-9, reference may be made to the diagrams of FIGS. 1-3 to provide contextual examples. Implementation, however, is not limited to those examples.

Referring to Fig, 4, in step 38 a plurality of user defined classification controls are caused to be displayed in a user interface proximal to a plurality of a plurality of objects managed by an application. The classification controls are caused to be displayed such that user interface actions can visually link any plurality of the managed objects to any given one of the classification controls. Referring to FIG. 2, display engine 24 may be responsible for implementing step 38. Referring ahead, FIG. 5-8 depicts a screen view in which classification control are displayed in the manner of step 38. FIG. 8, in particular depicts a user interface action visually linking a plurality of managed objects to a given classification control.

Each classification control caused to be displayed in step 38 may correspond to a different user specified tag. A tag control may also be caused to be displayed in step 38. Based on a user interaction with that tag control, the plurality of classification controls are altered. Referring to FIG. 2, definition engine 22 is responsible for altering the classification controls. Altering can include defining a new classification control and corresponding tag as depicted in FIGS. 6 and 7 below. Altering can also include modifying the tag of an existing classification control or deleting a classification control.

Continuing with FIG. 3, a user interface action visually linking a selected one of the objects to a selected one of the classification controls is detected (step 40). Such a user interface action may involve the particular managed object being dragged and dropped on the given classification control as depicted in the example of FIG. 8 discussed below. The selected one of the managed objects is then tagged with data corresponding to the selected one of the classification controls (step 42). Tagging engine 26 of FIG. 2 may be responsible for implementing steps 40 and 42.

Steps 40 and 42 can be repeated until a plurality of the managed objects are tagged allowing the display of the managed objects to be filtered according to the data tagged to the managed objects. Such filtering, for example, may be initiated by the user's selection of a particular classification control. In an example, one set or plurality of managed objects may be tagged with data corresponding to one classification control while a second set or plurality of managed object may be tagged with data corresponding to a second classifications control. Upon the user's later selection of the first classification control, the display of the managed objects may be filtered such that the first plurality of manage objects are visually distinguishable as a set different from the second plurality of managed objects. FIG. 9 discussed below provides an example. Further, referring to FIG. 2, display engine 24 may be responsible for filtering the display of the managed object based upon detecting a user's interaction with a given classification control.

Moving on to the screen views of FIGS. 5-9, an example user interface 44 implementing embodiments described above is depicted. Starting with FIG. 5, user interface 44 is shown to display a plurality of managed objects 46, a plurality of classification controls 48, and tag control 50. In the example of FIG. 5, three classification controls 48 are displayed proximal to the managed objects 46. Each managed object 46 is displayed as data in a row. In this example, the data for each managed object 46 relates to an application defect to be addressed. Of course different application may manage other objects such as e-mails, IT incidents, projects, or other tasks.

Moving to FIG. 6, a user has interacted with tag control 60 a specified a tag for a new classification control. Here, the user has specified the name “Due Tomorrow” as the tag or data to be associated with the new classification control. In FIG. 7, the new classification control 48′ has been added, thus modifying the existing plurality of classification controls.

FIG. 8 depicts a user interface action visually linking three of the managed objects 46 with the newly added classification control 48′. In this example, the user selected the three managed objects and dragged and dropped those objects 54 onto classification control 48′. As a result those three managed objects 48′ were tagged “Due Tomorrow”. In FIG. 9, the user has selected classification control 48′ causing the display of manage objects 46 to be filtered to display only the three objects 54 tagged “Due Tomorrow” 52.

Referring back to FIG. 2, display engine 24 is responsible for causing the display of classification controls 48 and tag control 50. Definition engine 22 is responsible for defining classification controls 48 based on user input defining the tags for each control 48. Tagging engine 26 is responsible for detecting user interface actions visually linking the managed objects to classification controls 48 and tagging each managed object according to the classification object 48 to which it was visually linked. Display engine 24 may also be responsible for filtering the display of the manage objects 46 according to their tags.

Ultimately, FIGS. 5-9 depict a user interface that enables a user to define a series of classification controls 48 and then selectively tag managed objects by visually linking those objects to a desired classification control 48. The placement of the classification controls allows the user to simultaneously tag multiple managed objects with data corresponding to a selected one of the classification controls. Moreover, the user can simply select a classification control 48 to then filter the display of the managed objects to highlight the managed objects tagged using that classification control.

Conclusion:

FIGS. 1-3 depict the architecture, functionality, and operation of various embodiments. In particular, FIGS. 2-3 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable medium for use by or in connection with an instruction execution system such as a computer/processor based system or an ASIC (Application Specific Integrated Circuit) or other system that can fetch or obtain the logic from computer-readable medium and execute the instructions contained therein. “Computer-readable medium” can be any non-transitory storage medium that can contain, store, or maintain a set of instructions and data for use by or in connection with the instruction execution system. A computer readable medium can comprise any one or more of many physical, non-transitory media such as, for example, electronic, magnetic, optical, electromagnetic, or semiconductor media. More specific examples of a computer-readable medium include, but are not limited to, a portable magnetic computer diskette such as floppy diskettes, hard drives, solid state drives, random access memory (RAM), read-only memory (ROM), erasable programmable read-only memory, flash drives, and portable compact discs.

Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention. Furthermore, the example screen views of FIGS. 5-9 are just that, examples. The screen views are provided illustrate just one example of the use of classification controls displayed proximal to a plurality of managed objects.

The present invention has been shown and described with reference to the foregoing exemplary embodiments. It is to be understood, however, that other forms, details and embodiments may be made without departing from the spirit and scope of the invention that is defined in the following claims.

What is claimed is:

1. An object tagging method comprising:
in a user interface displaying managed objects, causing a display of a plurality of user defined classification controls proximal to the objects such that user interface actions can visually link any plurality of the managed objects to any given one of the classification controls;
detecting a user interface action visually linking a selected one of the objects to a selected one of the classification controls; and
tagging the selected one of the objects with data corresponding to the selected one of the classification controls.

2. The method of claim 1, wherein causing comprises causing a display of a plurality of user defined interface classification controls wherein each classification control corresponds to a different user specified tag.

3. The method of claim 2, comprising:
in the user interface, causing a display of a tag control; and
altering the plurality of classification controls according to a user interaction with the tag control;
wherein altering comprises at least one of adding a classification control to the plurality of classification controls, removing a control from the plurality of classification controls, and altering a tag corresponding to a selected one of the plurality of classification controls.

4. The method of claim 1, wherein detecting comprises detecting a user interface action in which the selected object is dragged and dropped on the selected classification control.

5. The method of claim 1, comprising:
repeating the detecting and tagging with respect to a plurality of the managed objects; and
filtering the display of the managed objects according the data tagged to the plurality of the managed objects.

6. The method of claim 5, wherein:
detecting comprises detecting a first plurality of user interface actions visually linking a first plurality of the managed objects with a first one of the user defined classification controls and detecting a second plurality of user interface actions visually linking a second plurality of the managed objects with a second one of the user defined classification controls;
tagging comprises tagging each of the first plurality of managed objects with data corresponding to the first one of the user defined classification controls and tagging each of the second plurality of managed objects with data corresponding to the second one of the user defined classification controls; and
filtering comprises filtering the display of the managed objects such that the first plurality of manage objects are visually distinguishable as a set different from the second plurality of managed objects.

7. A computer readable medium having instructions stored thereon that when executed by a processing resource implement a system comprising:
a definition engine configured to define a plurality of classification accessible controls according to user input;
a display engine configured to cause, in a user interface displaying managed objects, a display of the plurality of user defined classification controls proximal to the objects such that user interface actions can visually link any plurality of the managed objects to any given one of the classification controls; and
a tagging engine configured to tag a selected one of the objects with data corresponding to a selected one of the classification controls upon detecting a user interface action visually linking the selected object to the selected classification control.

8. The medium of claim 7, wherein the definition engine is configured to define by defining a plurality of classification controls according to user input wherein each classification control corresponds to a different user specified tag.

9. The medium of claim 8, wherein the display engine is configured to, in the user interface, cause a display of a tag control, and the definition engine is configured to:
alter the plurality of classification controls according to a user interaction with the tag control;
wherein altering comprises at least one of adding a classification control to the plurality of classification controls, removing a control from the plurality of classification controls, and altering a tag corresponding to a selected one of the plurality of classification controls.

10. The medium of claim 7, wherein the tagging engine is configured to detect the user interface action visually linking the selected object to the selected classification control, the user interface action being one in which the selected object is dragged and dropped on the selected classification control.

11. The medium of claim 7, wherein:
the detection engine is configured to, for each of a plurality of the objects, tag that object to a given one of the classification controls upon detecting a user interface action visually linking that selected object to the that selected classification control; and
the display engine is configured to filter the display of the managed objects according the data tagged to the plurality of the managed objects.

12. The medium of claim 11, wherein the tagging engine is configured to:
detect a first plurality of user interface actions visually linking a first plurality of the managed objects with a first one of the user defined classification controls;
detect a second plurality of user interface actions visually linking a second plurality of the managed objects with a second one of the user defined classification controls;
tag each of the first plurality of managed objects with data corresponding to the first one of the user defined classification controls; and
tag each of the second plurality of managed objects with data corresponding to the second one of the user defined classification controls; and
wherein the display engine is configured to filter the display of the managed objects such that the first plurality of manage objects are visually distinguishable as a set different from the second plurality of managed objects.

13. A system for tagging objects managed by an application. the system comprising a non-tangible computer readable medium storing instructions that when executed by a processing resource implement a method, the method comprising:
in a user interface displaying managed objects, causing a display of a plurality of user defined classification controls proximal to the objects such that user interface actions can visually link any plurality of the managed objects to any given one of the classification controls;
detecting a user interface action visually linking a selected one of the objects to a selected one of the classification controls; and
tagging the selected one of the objects with data corresponding to the selected one of the classification controls.

14. The system of claim 13, further comprising the processing resource.

15. The system of claim 13, wherein causing comprises causing a display of a plurality of user defined interface classification controls wherein each classification control corresponds to a different user specified tag.

16. The system of claim 15, wherein the method comprises:
in the user interface, causing a display of a tag control; and
altering the plurality of classification controls according to a user interaction with the tag control;
wherein altering comprises at least one of adding a classification control to the plurality of classification controls, removing a control from the plurality of classification controls, and altering a tag corresponding to a selected one of the plurality of classification controls.

17. The system of claim 13, wherein detecting comprises detecting a user interface action in which the selected object is dragged and dropped on the selected classification control.

18. The system of claim 13, wherein the method comprises:
repeating the detecting and tagging with respect to a plurality of the managed objects; and
filtering the display of the managed objects according the data tagged to the plurality of the managed objects.

19. The system of claim 18, wherein:
detecting comprises detecting a first plurality of user interface actions visually linking a first plurality of the managed objects with a first one of the user defined classification controls and detecting a second plurality of user interface actions visually linking a second plurality of the managed objects with a second one of the user defined classification controls;
tagging comprises tagging each of the first plurality of managed objects with data corresponding to the first one of the user defined classification controls and tagging each of the second plurality of managed objects with data corresponding to the second one of the user defined classification controls; and
filtering comprises filtering the display of the managed objects such that the first plurality of manage objects are visually distinguishable as a set different from the second plurality of managed objects.
